(19) United States
(12) Patent Application Publication
(10) Pub. No.: US 2026/0267007 A1
(43) Pub. Date: Sep. 10, 2026

(54) CARRIER PHASE PROCESSING

(71) Applicant: SAMSUNG ELECTRONICS CO., LTD., SUWON-SI (KR)

(72) Inventors: RAYMAN PON, CUPERTINO, CA (US); ALI JAFARNIA JAHROMI, SAN JOSE, CA (US)

(21) Appl. No.: 19/555,566

(22) Filed: Mar. 3, 2026

Related U.S. Application Data
(60) Provisional application No. 63/767,158, filed on Mar. 5, 2025.

(51) Int. Cl. G01S 19/29

(52) U.S. Cl. CPC G01S 19/29

(57) ABSTRACT

A system and a method are disclosed for processing carrier phase measurements. Such a process includes detecting one or more carrier phase discontinuities associated with a raw carrier phase; compensating the raw carrier phase based on an accumulation of each carrier phase discontinuity of the one or more carrier phase discontinuities; and generating a net compensated carrier phase including the compensation to the raw carrier phase.

### CROSS-REFERENCE TO RELATED APPLICATION

This application claims the priority benefit under 35 U.S.C. § 119 (e) of U.S. Provisional Application No. 63/767,158, filed on Mar. 5, 2025, the disclosure of which is incorporated by reference in its entirety as if fully set forth herein.

### TECHNICAL FIELD

The disclosure generally relates to carrier phase processing. More particularly, the subject matter disclosed herein relates to improvements in the detection, interpretation, and continuity of phase-based measurements that may enhance the reliability, stability, and overall performance of systems that depend on accurate phase information.

### SUMMARY

Global Navigation Satellite System (GNSS) receivers can integrate carrier phase tracking loops, correlators, numerically controlled oscillators, and frequency discriminators so that incoming satellite signals may be converted into continuous phase measurements. These GNSS receivers can operate on in-phase and quadrature accumulations that may be generated over defined pre-detection intervals so that carrier phase may be estimated with suitable sensitivity. As receiver designs increasingly employ low-cost crystal oscillators that exhibit large frequency variation during thermal events (e.g., modem call activation and deactivation), the carrier loops can encounter abrupt frequency excursions that may exceed the tracking capability of associated GNSS receivers. Loss of carrier phase lock during such excursions may cause the observed carrier phase to spin within an in-phase and quadrature domain and may result in unaccounted carrier phase rollovers that can disrupt the continuity of phase measurements needed for precise positioning.

To solve this problem, existing GNSS receivers may be configured to modify carrier tracking behavior so that the carrier loops may react more rapidly to abrupt changes in apparent signal frequency caused by oscillator induced dynamics. Some GNSS receivers may be configured to increase the order of the carrier tracking loop so that higher order motion (e.g., acceleration) may be accommodated, while other GNSS receivers may be configured to expand loop bandwidth so that the loop may follow faster frequency excursions. Additional GNSS receivers may be configured to shorten the pre-detection interval so that carrier phase measurements may be updated more frequently and may track rapid phase rotation with reduced delay.

One issue with the above approach is that increasing loop order or loop bandwidth may introduce additional noise and stability constraints. Another issue with the above approach is that shortening the pre-detection interval may reduce carrier phase sensitivity by several decibels. These limitations may prevent the loops from fully accommodating large and abrupt oscillator induced dynamics, which may continue to cause temporary loss of carrier phase lock and leave the number of carrier phase rollovers unresolved during each pre-detection interval.

To overcome these issues, systems and methods are described herein for generating a compensated carrier phase that can preserve continuity across temporary loss of lock conditions. These systems can compute an expected carrier phase for each pre-detection interval using a smoothed frequency error estimate derived from an automatic frequency control discriminator, compare the expected carrier phase to an observed raw carrier phase, identify a rollover candidate whose phase transition is closest to the smoothed frequency error, accumulate rollover counts across the pre-detection intervals, and apply the accumulated rollover counts to the raw carrier phase to so that an observable compensated carrier phase may be produced. However, it is understood that other operations may support the functionality of the disclosed system, as is further described herein.

The above approaches improve on previous methods because they can maintain long coherent integration intervals while reliably detecting carrier phase rollovers, preserve carrier phase continuity during large oscillator induced dynamics, and provide higher quality carrier phase, pseudo-range, and pseudo-range rate observables for downstream positioning operations.

In an embodiment, a method comprises detecting one or more carrier phase discontinuities associated with a raw carrier phase; compensating the raw carrier phase based on an accumulation of each carrier phase discontinuity of the one or more carrier phase discontinuities; and generating a net compensated carrier phase including the compensation to the raw carrier phase.

In an embodiment, an apparatus comprises a computer processor and a computer memory operatively coupled to the computer processor, wherein the computer memory has computer program instructions disposed within it that, when executed by the computer processor, cause the apparatus to carry out the steps of detecting one or more carrier phase discontinuities associated with a raw carrier phase; compensating the raw carrier phase based on an accumulation of each carrier phase discontinuity of the one or more carrier phase discontinuities; and generating a net compensated carrier phase including the compensation to the raw carrier phase.

In an embodiment, a computer-readable media storing processor-executable instructions that, when executed by at least one processor, cause the at least one processor to detect one or more carrier phase discontinuities associated with a raw carrier phase; compensate the raw carrier phase based on an accumulation of each carrier phase discontinuity of the one or more carrier phase discontinuities; and generate a net compensated carrier phase including the compensation to the raw carrier phase.

### BRIEF DESCRIPTION OF THE DRAWING

In the following section, the aspects of the subject matter disclosed herein will be described with reference to exemplary embodiments illustrated in the figures, in which:

FIG. 1 illustrates a block diagram of an example system for carrier phase processing according to embodiments of the present disclosure.

FIG. 2 sets forth a block diagram illustrating an example architecture for carrier phase monitoring and rollover/discontinuity compensation according to embodiments of the present disclosure.

FIG. 3-8 set forth flowcharts illustrating example methods for carrier phase processing according to embodiments of the present disclosure.

FIG. 9 is a block diagram of an electronic device in a network environment according to embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Reliable raw carrier phase,” as used herein, refers to a raw carrier phase observation that is consistent with expected phase behavior for a corresponding pre-detection interval. A raw carrier phase may be considered reliable when one or more signal characteristics indicate stable tracking conditions. Examples of such characteristics may include a carrier-to-noise density ratio above a minimum operational threshold, a lock indicator associated with the carrier tracking loop remaining within an acceptable range, a discriminator output or phase-innovation value that reflects predictable phase rotation, or consistency between the raw carrier phase and a corresponding filtered frequency error estimate. A reliable raw carrier phase may therefore be used as a basis for discontinuity detection, cycle accumulation, and generation of a net compensated carrier phase.

“Unreliable raw carrier phase,” as used herein, refers to a raw carrier phase observation that does not reliably reflect the underlying phase of the received signal for a corresponding pre-detection interval. A raw carrier phase may be considered unreliable when one or more signal characteristics indicate degraded or unstable tracking conditions. Examples of such characteristics may include a carrier-to-noise density ratio below a minimum threshold, a lock indicator suggesting partial or complete loss of lock, a discriminator output or phase-innovation value indicating excessive deviation from expected phase progression, or substantial inconsistency between the raw carrier phase and a filtered frequency error estimate. An unreliable raw carrier phase may prompt the signal processing system to limit or reject compensation operations.

“Carrier phase,” as used herein, refers to a phase measurement derived from the accumulated rotation of a carrier component of a received signal over one or more pre-detection intervals. A carrier phase value may represent the phase angle of an in-phase and quadrature vector generated by a carrier tracking loop and may be expressed modulo the periodicity of the loop (e.g., ±180 degrees for a phase-locked loop or ±90 degrees for a discriminator operating with a ±90-degree periodicity). Carrier phase measurements may be used to support fine-range estimation, tracking-loop stabilization, or high-precision phase-based processing within a signal processing system.

“Raw carrier phase,” as used herein, refers to an unadjusted carrier phase observation produced by a carrier tracking loop for a given pre-detection interval. The raw carrier phase may reflect instantaneous phase conditions that include the effects of satellite motion, user dynamics, oscillator variations, noise, and tracking-loop behavior. The raw carrier phase may also contain discontinuities caused by loop periodicity, temporary loss-of-lock conditions, or abrupt frequency excursions.

“Pre-detection interval,” as used herein, refers to a coherent integration period during which in-phase and quadrature accumulations are generated prior to carrier phase discrimination or tracking-loop updates. A pre-detection interval may define the temporal resolution at which carrier phase observations, frequency error estimates, and phase differences are computed by the signal processing system. In some embodiments, the pre-detection interval may be shorter than a measurement generation interval used to produce a carrier phase measurement for downstream positioning. In such configurations, the signal processing system may accumulate carrier phase discontinuities at each pre-detection interval and apply the accumulated discontinuities when generating the compensated carrier phase for the longer measurement generation interval.

“Frequency error estimate,” as used herein, refers to an indication of the instantaneous frequency offset between an expected signal frequency and a received signal frequency for a given pre-detection interval. A frequency error estimate may be generated by a discriminator within the carrier tracking loop and may reflect short-term oscillator behavior, Doppler dynamics, or noise.

“Filtered frequency error estimate,” as used herein, refers to a smoothed or refined representation of the frequency error estimate generated using one or more filtering techniques. A filtered frequency error estimate may suppress high-frequency noise or transient disturbances and may provide a stable signal used for determining an expected carrier phase, identifying phase-related candidates, or detecting abnormal frequency behavior.

“Delta carrier phase,” as used herein, refers to a measure of carrier phase change between successive pre-detection intervals. A delta carrier phase may be determined using smoothed or raw carrier phase observations and may support subsequent operations such as discontinuity detection, frequency refinement, or compensation of the raw carrier phase.

“Carrier phase discontinuity,” as used herein, refers to an event in which the observed carrier phase value experiences a non-continuous transition across successive pre-detection intervals. Examples of carrier phase discontinuities may include, but are not limited to, phase transitions that exceed a defined periodicity of a loop, phase jumps resulting from temporary loss-of-lock within the carrier tracking loop, or abnormal phase changes caused by noise or oscillator-induced dynamics.

“Carrier phase rollover,” as used herein, refers to a carrier phase discontinuity in which the observed carrier phase wraps from one boundary of the loop periodicity to the opposite boundary. For example, in a phase-locked loop with a ±180-degree periodicity, a rollover may occur when the underlying phase transition crosses the ±180-degree boundary, while in a discriminator operating with a ±90-degree periodicity, the rollover may occur at ±90 degrees. Carrier phase rollovers may require compensation to reconstruct a continuous carrier phase history.

“Cycle slip,” as used herein, refers to a carrier phase discontinuity associated with a temporary loss-of-lock or a failure of the tracking loop to maintain phase coherence across one or more pre-detection intervals. A cycle slip may produce one or more whole-cycle errors in the carrier phase measurement.

“Phase-related candidate,” as used herein, refers to an adjusted interpretation of a measured carrier phase difference that incorporates one or more phase-related integers consistent with the loop periodicity of the phase-locked loop. A phase-related candidate may be evaluated by comparing integer-adjusted versions of a phase difference to a filtered frequency error estimate and selecting the adjusted value that most closely aligns with expected phase behavior for the corresponding pre-detection interval.

“Accumulated representation,” as used herein, refers to a stored value that represents an aggregation of carrier phase discontinuities detected across successive pre-detection intervals. The accumulated representation may include whole-cycle or half-cycle transitions associated with rollovers and may support compensation of the raw carrier phase or the generation of a net compensated carrier phase.

“Net compensated carrier phase,” as used herein, refers to a carrier phase value that incorporates compensation based on an accumulated representation of detected discontinuities. The net compensated carrier phase may represent a continuous phase history that is suitable for downstream processing, positioning, or real-time control operations.

“Signal-related threshold,” as used herein, refers to a threshold value used to assess whether compensation applied to a raw carrier phase is reliable for a given measurement interval. Examples of a signal-related threshold may include a maximum permissible magnitude of carrier phase compensation, a minimum carrier-to-noise density ratio, a lock-indicator reliability metric, a tolerance based on consistency between a delta carrier phase and a filtered frequency error estimate, or a limit derived from phase-innovation or cross-channel consistency checks. Compensation that exceeds the signal-related threshold may be treated as indicative of unreliable carrier phase behavior.

“Phase-locked loop,” as used herein, refers to a tracking loop configured to maintain phase coherence between a received carrier signal and an internally generated reference signal. A phase-locked loop may operate according to a defined phase periodicity that reflects the range over which phase is unambiguously represented within the loop. Examples of such periodicities may include ±90 degrees, ±180 degrees, or other loop-specific phase ranges, depending on the discriminator configuration and tracking architecture. A phase-locked loop may output raw carrier phase observations, instantaneous frequency error estimates, or discriminator metrics used to support the carrier phase processing techniques described herein.

“Loop periodicity,” as used herein, refers to the phase range over which a phase-locked loop represents phase values before a rollover occurs. Loop periodicity may define the allowable interval within which the phase discriminator operates without ambiguity. Examples of loop periodicities may include ±90 degrees, ±180 degrees, or other periodic ranges determined by the discriminator structure of the phase-locked loop. Loop periodicity may be used by the signal processing system to determine appropriate phase-related integers during various operations described herein.

“Flag,” as used herein, refers to a notification generated by the signal processing system to indicate that compensation of the raw carrier phase exceeds a signal-related threshold or that the carrier phase measurement is otherwise unreliable. A flag may be transmitted to an external system, positioning engine, or real-time controller for use in down-weighting or excluding a corresponding carrier phase measurement.

“Compensation to the raw carrier phase,” as used herein, refers to adjusting the raw carrier phase by a number of cycles determined from an accumulated representation of detected carrier phase discontinuities so that the resulting compensated carrier phase forms a continuous phase observable.

GNSS receivers continue to encounter significant challenges as thermal events and user-driven dynamics induce abrupt frequency excursions that may exceed the tracking capability of associated carrier phase loops. Each pre-detection interval may require the receiver to maintain phase lock on incoming satellite signals so that the observed carrier phase can remain continuous and suitable for precise positioning. When oscillator induced dynamics drive the instantaneous frequency outside the range that the carrier loop can track, the observed carrier phase may rotate rapidly within the in-phase and quadrature domain and produce carrier phase rollovers that the loop cannot account for. These untracked rollovers can interrupt carrier phase continuity, trigger cycle slip declarations, and reduce the availability and accuracy of carrier phase, pseudo-range, and pseudo-range rate observables needed for high precision positioning.

To address such challenges, the present disclosure sets forth various methods of carrier phase processing that can generate a compensated carrier phase based on detection and accumulation of carrier phase discontinuities that may occur during temporary loss of lock conditions. In one or more embodiments, the described methods may detect one or more carrier phase discontinuities associated with a raw carrier phase, determine a difference between an expected carrier phase and an actual carrier phase, and identify a phase-related candidate by comparing the difference to a filtered frequency error estimate. The described methods can accumulate each carrier phase discontinuity across pre-detection intervals and compensate the raw carrier phase based on the accumulated discontinuities so that a net compensated carrier phase may be generated. The described methods can further determine whether compensation of the raw carrier phase exceeds a signal-related threshold and transmit a flag when such conditions arise so that downstream systems may assess carrier phase reliability. These techniques may maintain long coherent integration intervals, track carrier phase rollovers with high fidelity, and provide improved carrier phase and pseudo-range rate observables for precise positioning applications.

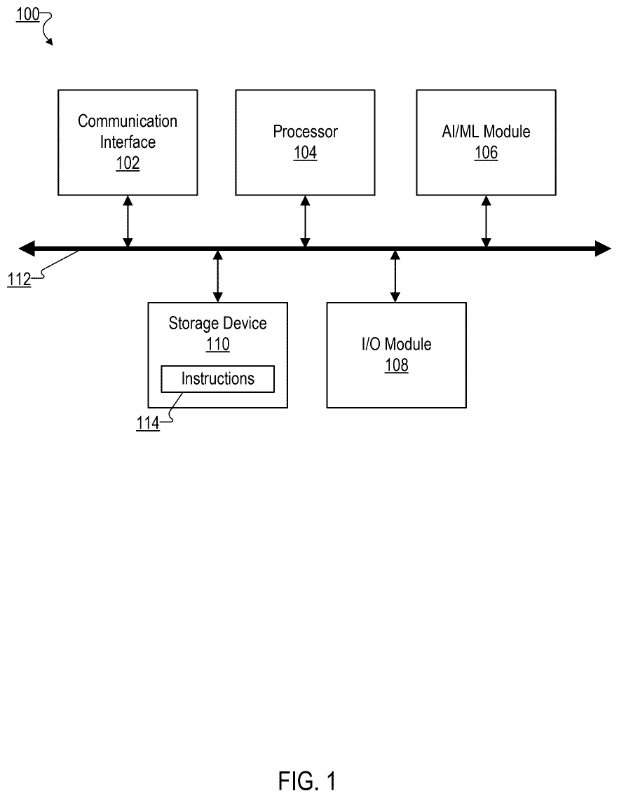

Example methods, systems, and products for carrier phase processing in accordance with embodiments of the present disclosure are described with reference to the accompanying drawings, beginning with FIG. 1. In one or more embodiments, FIG. 1 illustrates an example computing system 100 that may be specifically configured to perform one or more of the processes described herein associated with detecting one or more carrier phase discontinuities and generating a compensated carrier phase. As shown in FIG. 1, the computing system 100 may include a communication interface 102, a processor 104, an artificial intelligence and machine learning (AI/ML) module 106, an input and output (I/O) module 108, and a storage device 110 that stores computer-executable instructions 114. The communication interface 102, the processor 104, the AI/ML module 106, the I/O module 108, and the storage device 110 may be communicatively connected one to another via a communication infrastructure 112. The computer-executable instructions 114, when executed by the processor 104, may cause the computing system 100 to perform operations for carrier phase processing, including detecting one or more carrier phase discontinuities associated with a raw carrier phase, determining differences between expected and actual carrier phase values, identifying phase-related candidates based on filtered frequency error estimates, and generating a net compensated carrier phase for use by downstream positioning systems or for immediate real-time adjustments of the raw carrier phase. While an exemplary computing system 100 is shown in FIG. 1, the components illustrated are not intended to be limiting, and additional or alternative components may be used in other embodiments. Components of the computing system 100 shown in FIG. 1 will now be described in additional detail.

The communication interface 102 may be configured to communicate with one or more external components that can provide carrier tracking data, configuration parameters, or signal quality metrics to the computing system 100. For example, the communication interface 102 may receive in-phase and quadrature accumulations, one or more outputs from an automatic frequency control discriminator, or raw carrier phase measurements generated by a GNSS radio front end or by one or more satellite tracking channels. The communication interface 102 may also transmit compensated carrier phase values, cycle slip indicators, or diagnostic information to downstream positioning engines, navigation processors, or real-time control systems that may rely on timely phase measurements. Examples of the communication interface 102 include, without limitation, a wired or wireless transceiver, a high-speed serial interface, or an application programming interface (API) configured for structured data exchange within a GNSS processing pipeline. In some embodiments, the communication interface 102 may include mechanisms for authentication, data integrity verification, or forward-error correction to ensure reliable delivery of carrier phase information under dynamic environmental or operational conditions.

The processor 104 generally represents one or more processing units configured to execute operations associated with carrier phase processing within the computing system 100. The processor 104 may execute the computer-executable instructions 114 stored in the storage device 110 to perform operations such as detecting one or more carrier phase discontinuities associated with a raw carrier phase, determining a difference between an expected carrier phase and an actual carrier phase, and identifying a phase-related candidate based on a comparison between the difference and a filtered frequency error estimate. In some embodiments, the processor 104 may further execute instructions for accumulating carrier phase discontinuities across pre-detection intervals, compensating the raw carrier phase based on the accumulated discontinuities, and generating a net compensated carrier phase suitable for downstream positioning engines or real-time system adjustments. The processor 104 may include one or more general-purpose processing units, embedded control cores, or dedicated digital signal processing components configured to sustain deterministic execution of carrier phase processing workflows under varying satellite signal conditions.

The AI/ML module 106 may be configured to support predictive, filtering, or smoothing operations that can enhance the accuracy and stability of carrier phase processing within the computing system 100. In one or more embodiments, the AI/ML module 106 may receive frequency error estimates, in-phase and quadrature accumulations, or historical carrier phase data from the processor 104 and may generate a filtered frequency error estimate suitable for comparison with an observed carrier phase differential. The AI/ML module 106 may implement learned models, adaptive filters, or signal prediction techniques that can reduce noise associated with instantaneous frequency measurements, particularly under conditions in which oscillator induced dynamics or low signal levels affect carrier tracking performance. The AI/ML module 106 may further support dynamic thresholding, quality assessment, or anomaly detection processes that assist the processor 104 in determining whether compensation of a raw carrier phase exceeds a signal-related threshold. Through these operations, the AI/ML module 106 may provide stable and noise-reduced reference information that can enable accurate identification of phase-related candidates across successive pre-detection intervals.

The I/O module 108 may include one or more interfaces configured to receive configuration information and present system-generated outputs associated with carrier phase processing within the computing system 100. For input, the I/O module 108 may support interactions for defining processing parameters, selecting operating modes, specifying signal-related thresholds, or initiating diagnostic procedures related to carrier tracking performance. Input interfaces may include hardware controls, virtual controls, graphical configuration panels, or remote management utilities that can allow adjustment of processing behavior based on deployment requirements. For output, the I/O module 108 may present compensated carrier phase values, carrier phase discontinuity counts, cycle slip indicators, or quality metrics that can describe the accuracy and reliability of the net compensated carrier phase. Output interfaces may include displays, control terminals, logging modules, or network-accessible dashboards that can provide downstream systems or operators with visibility into carrier phase behavior. In some embodiments, the I/O module 108 may further support the export of compensated carrier phase observables or diagnostic summaries to navigation engines, external devices, or cloud-based analytical tools for additional processing or evaluation.

The storage device 110 may include one or more forms of non-volatile memory configured to store the computer-executable instructions 114 along with operational parameters, historical carrier phase data, and configuration records associated with carrier phase processing within the computing system 100. The storage device 110 may maintain data structures such as expected carrier phase models, filtered frequency error estimate parameters, carrier phase discontinuity logs, and threshold definitions used to determine whether compensation of a raw carrier phase exceeds a signal-related condition. In some embodiments, the storage device 110 may store diagnostic traces, processing statistics, and accumulated rollover counts that support performance assessment, validation, or system recovery. The storage device 110 may also store pre-detection interval timing information, signal quality indicators, or other metadata that may assist the processor 104 and the AI/ML module 106 in executing the carrier phase processing operations described herein. In certain embodiments, the storage device 110 may further integrate with remote or distributed storage repositories to support scalable retention of long-term carrier tracking records and configuration snapshots.

The communication infrastructure 112 represents the internal interconnect architecture that links the communication interface 102, the processor 104, the AI/ML module 106, the I/O module 108, and the storage device 110 within the computing system 100. The communication infrastructure 112 may include one or more buses, fabrics, or network topologies designed to support high-throughput and low-latency data transfer among these components during carrier phase processing operations. In some embodiments, the communication infrastructure 112 may provide dedicated pathways that allow the processor 104 to exchange frequency error estimates, carrier phase values, or discontinuity information with the AI/ML module 106 while maintaining separate control and monitoring channels for communication with the I/O module 108 and the storage device 110. The communication infrastructure 112 may ensure deterministic timing of carrier phase processing workflows across successive pre-detection intervals, enable synchronized updates of expected carrier phase values, filter frequency error estimates, and accumulate rollover counts. This configuration may support concurrent execution of data reception, computation, storage, and output operations needed to generate a net compensated carrier phase for downstream use.

The computer-executable instructions 114 stored in the storage device 110 may define operations that, when executed by the processor 104, configure the computing system 100 to perform one or more processes associated with carrier phase processing. These instructions 114 may specify routines for detecting one or more carrier phase discontinuities associated with a raw carrier phase, determining differences between expected and actual carrier phase values, identifying phase-related candidates based on filtered frequency error estimates, and compensating the raw carrier phase based on accumulated discontinuities. In some embodiments, the computer-executable instructions 114 may further define operations for generating a net compensated carrier phase, determining whether the compensation of the raw carrier phase exceeds a signal-related threshold, and transmitting a flag when the threshold is exceeded. The instructions 114 may also define workflows that coordinate operation of the communication interface 102, the processor 104, the AI/ML module 106, the I/O module 108, and the storage device 110 to support continuous carrier phase monitoring across successive pre-detection intervals and to provide compensated carrier phase values suitable for downstream positioning systems or real-time adjustment components.

By combining these components, the computing system 100 may be specifically configured to execute the processes described herein for carrier phase processing. In particular, the computing system 100 may support operations for detecting one or more carrier phase discontinuities associated with a raw carrier phase, determining an expected carrier phase based on filtered frequency error estimates, identifying a phase-related candidate that corresponds to a rollover event, and generating a net compensated carrier phase that reflects accumulated discontinuities across pre-detection intervals. The integrated architecture of the computing system 100 may enable efficient coordination among signal reception, frequency error estimation, carrier phase adjustment, and quality assessment, thereby supporting continuous and reliable carrier phase tracking under dynamically varying oscillator and signal conditions. Through coordinated operation of the communication interface 102, the processor 104, the AI/ML module 106, the I/O module 108, and the storage device 110, the computing system 100 may form a scalable and adaptable platform for generating compensated carrier phase observables for downstream navigation engines and real-time adjustment components.

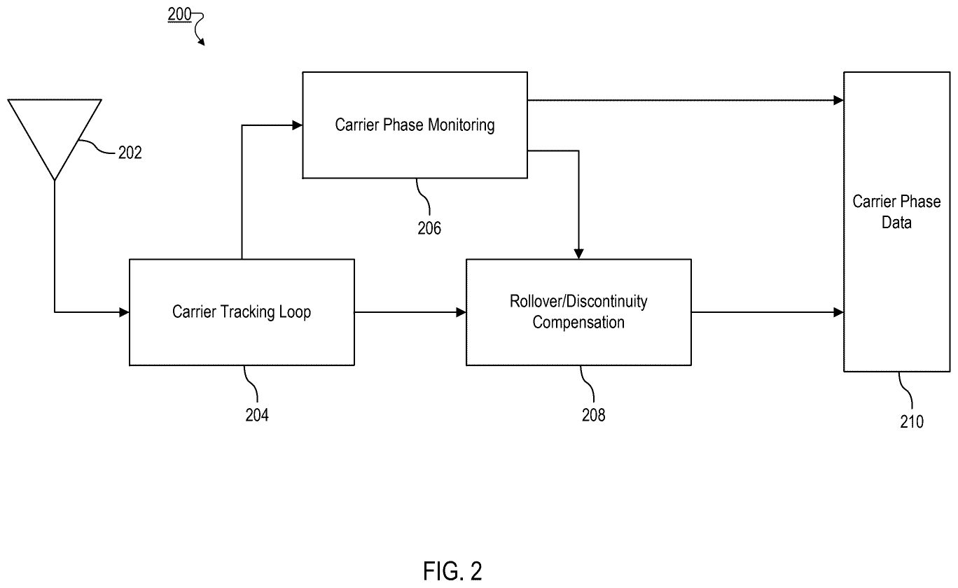

FIG. 1 therefore illustrates an example computing system 100 configured to perform operations associated with carrier phase processing. The described configuration may enable the computing system 100 to detect carrier phase discontinuities, determine expected carrier phase values based on filtered frequency error estimates, identify phase-related candidates corresponding to rollover events, and compensate raw carrier phase values based on accumulated discontinuities. By providing coordinated processing across the communication interface 102, the processor 104, the AI/ML module 106, the I/O module 108, and the storage device 110, the computing system 100 may generate net compensated carrier phase values for use by downstream positioning engines or real-time adjustment components. The modular design of the computing system 100 may allow integration within GNSS receivers, embedded signal processing platforms, or distributed navigation systems, supporting scalable deployment across a range of carrier phase processing applications. FIG. 2 illustrates an example carrier phase processing architecture that can build upon the computing system 100 and further defines the functional components, data flows, and signal processing operations used to detect discontinuities, accumulate rollover counts, and generate net compensated carrier phase values in accordance with embodiments of the present disclosure.

For further explanation, FIG. 2 sets forth a block diagram of an example carrier phase processing architecture 200 that may be specifically configured to perform one or more of the signal processing operations described herein. In one or more embodiments, the carrier phase processing architecture 200 may operate within a GNSS receiver or integrated navigation platform and may receive input data from one or more satellite tracking channels that generate in-phase and quadrature accumulations, raw carrier phase values, and frequency-related discriminator outputs. As shown in FIG. 2, the carrier phase processing architecture 200 may include signal source(s) 202, a carrier tracking loop 204, a carrier phase monitoring module 206, and a rollover/discontinuity compensation module 208 that may exchange data with a carrier phase data interface 210. The signal source(s) 202, the carrier tracking loop 204, the carrier phase monitoring module 206, and the rollover/discontinuity compensation module 208 may be communicatively connected and may cooperate to detect carrier phase discontinuities, accumulate rollover information, and generate a compensated carrier phase value suitable for downstream processing or real-time adjustment operations.

The signal source(s) 202 may represent one or more components configured to provide carrier tracking information to the carrier phase processing architecture 200. In one or more embodiments, the signal source(s) 202 may include one or more satellite tracking channels, correlator outputs, or front-end processing elements that generate in-phase and quadrature accumulations for each pre-detection interval. The signal source(s) 202 may further provide raw carrier phase values and frequency-related discriminator outputs derived from received GNSS signals, including instantaneous frequency error estimates that reflect oscillator induced dynamics or user-driven motion. In some embodiments, the signal source(s) 202 may deliver additional information such as signal strength indicators, noise estimates, or channel-specific tracking metadata, enabling downstream components to evaluate tracking quality and to determine whether the carrier phase monitoring module 206 should treat a given carrier phase update as reliable. Through these operations, the signal source(s) 202 may supply the carrier tracking loop 204, the carrier phase monitoring module 206, and the rollover/discontinuity compensation module 208 with the data required to perform carrier phase processing across successive pre-detection intervals.

The carrier tracking loop 204 may be configured to observe raw carrier phase values and to generate frequency-related discriminator outputs based on the in-phase and quadrature accumulations provided by the signal source(s) 202. In one or more embodiments, the carrier tracking loop 204 may include one or more numerically controlled oscillators, correlator accumulators, phase discriminators, and loop filters that may operate together to maintain carrier phase lock under conditions associated with a reliable raw carrier phase, as defined herein. The carrier tracking loop 204 may determine instantaneous carrier phase observations for each pre-detection interval and may produce corresponding discriminator outputs that can represent short-term deviations between expected and received signal frequencies. These discriminator outputs may reflect frequency dynamics induced by oscillator behavior, user movement, or environmental effects and may be used by the carrier phase monitoring module 206 to determine whether a carrier phase discontinuity has occurred. In some embodiments, the carrier tracking loop 204 may also generate intermediate tracking metrics such as lock indicators or carrier-to-noise density ratios, enabling downstream modules to assess the reliability of raw carrier phase observations and to adjust processing behavior in response to varying signal conditions.

The carrier phase monitoring module 206 may be configured to analyze the raw carrier phase observations received from the carrier tracking loop 204 and to detect one or more carrier phase discontinuities that may occur across successive pre-detection intervals. In one or more embodiments, the carrier phase monitoring module 206 may determine a difference between an expected carrier phase and an actual carrier phase for a given pre-detection interval, where the expected carrier phase may be computed using filtered frequency error estimates and prior carrier phase information. The carrier phase monitoring module 206 may generate multiple phase-related candidates that represent possible rollover-adjusted interpretations of the observed carrier phase change and may identify a candidate that most closely aligns with the filtered frequency error estimate provided by upstream processing elements. The carrier phase monitoring module 206 may further determine the magnitude and direction of any detected carrier phase discontinuity and may provide discontinuity information to the rollover/discontinuity compensation module 208 for accumulation and compensation. In some embodiments, the carrier phase monitoring module 206 may also assess the quality of observed carrier phase values and may suppress or qualify discontinuity detection when signal-level metrics indicate unreliable tracking conditions.

The rollover/discontinuity compensation module 208 may be configured to accumulate discontinuity information received from the carrier phase monitoring module 206 and to generate a compensated carrier phase that reflects continuous phase progression across successive pre-detection intervals. In one or more embodiments, the rollover/discontinuity compensation module 208 may maintain an accumulated count of carrier phase discontinuities, including whole-cycle or half-cycle adjustments identified by the carrier phase monitoring module 206. The rollover/discontinuity compensation module 208 may apply the accumulated discontinuities to the raw carrier phase observations to generate a compensated carrier phase that incorporates all rollover events detected during temporary loss of lock conditions. In some embodiments, the rollover/discontinuity compensation module 208 may further determine whether the compensation applied to the raw carrier phase exceeds a signal-related threshold that may indicate unreliable processing conditions and may transmit a flag to the carrier phase data interface 210 or downstream systems when such a condition occurs. Through these operations, the rollover/discontinuity compensation module 208 may provide a continuous and reliable representation of the carrier phase suitable for downstream positioning engines or real-time adjustment components.

The carrier phase data interface 210 may be configured to exchange data directly with one or more components of the carrier phase processing architecture 200. In one or more embodiments, the carrier phase data interface 210 may receive a flag generated by the carrier phase monitoring module 206 when a detected carrier phase discontinuity or associated compensation exceeds a signal-related threshold, enabling downstream systems to evaluate the reliability of the corresponding carrier phase observations. The carrier phase data interface 210 may also receive a compensated carrier phase generated by the rollover/discontinuity compensation module 208, along with accumulated rollover information, cycle slip indicators, or associated quality metrics. The carrier phase data interface 210 may further provide configuration parameters, threshold definitions, diagnostic requests, or operational commands that may be consumed by the carrier tracking loop 204, the carrier phase monitoring module 206, or the rollover/discontinuity compensation module 208. These exchanges may enable dynamic control of carrier phase processing behavior based on navigation requirements, system conditions, or feedback from downstream positioning engines. In some embodiments, the carrier phase data interface 210 may support structured data formatting, timing alignment, or integrity verification procedures that can ensure carrier phase information transmitted to or received from the carrier phase processing architecture 200 maintains consistency, reliability, and compatibility with external navigation or real-time adjustment systems.

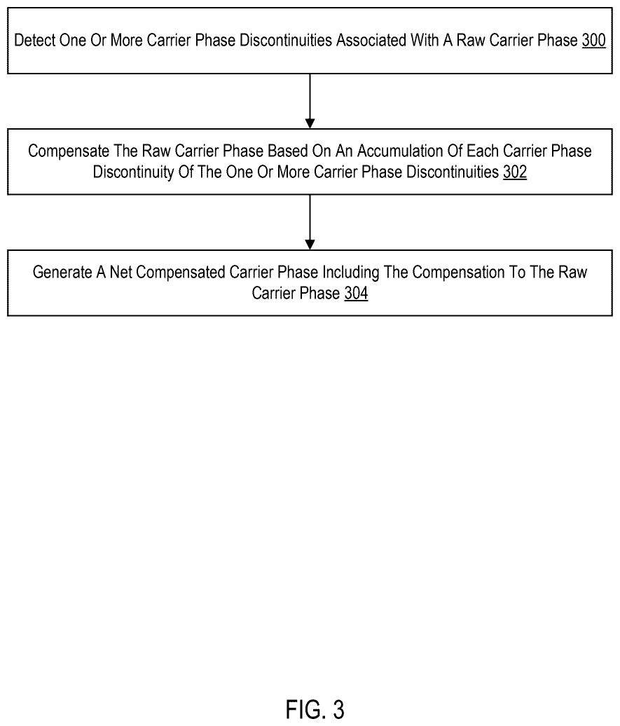

FIG. 2 therefore illustrates an example carrier phase processing architecture 200 configured to observe raw carrier phase values, detect carrier phase discontinuities, accumulate rollover information, and generate compensated carrier phase values for downstream use. The described configuration may enable the carrier tracking loop 204, the carrier phase monitoring module 206, and the rollover/discontinuity compensation module 208 to operate cooperatively across successive pre-detection intervals, supporting reliable carrier phase continuity under dynamically varying oscillator and signal conditions. Through coordinated operation of these components and data exchanges with the carrier phase data interface 210, the carrier phase processing architecture 200 may provide a scalable and adaptable framework for continuous carrier phase monitoring and compensation. FIG. 3 illustrates an example method that may be executed by the carrier phase processing architecture 200 and further specifies a sequence of operations for detecting carrier phase discontinuities, generating rollover information, and producing net compensated carrier phase values in accordance with embodiments of the present disclosure.

For further explanation, FIG. 3 sets forth a flowchart illustrating an example method of carrier phase processing in accordance with embodiments of the present disclosure. The example method of FIG. 3 can be carried out in a system similar to that of FIG. 2 and in consideration of a computing system, such as the computing system 100 illustrated in FIG. 1. In one or more embodiments, the method of FIG. 3 can be performed by a signal processing system that may be represented by the processor 104 illustrated as a component of the computing system 100.

The method of FIG. 3 includes detecting 300 one or more carrier phase discontinuities associated with a raw carrier phase. Detecting 300 may be carried out by the signal processing system by observing raw carrier phase values provided by a carrier tracking loop (e.g., the carrier tracking loop 204) for each pre-detection interval and determining whether the raw carrier phase values exhibit discontinuous behavior indicative of a carrier phase rollover. For example, the signal processing system may compare the raw carrier phase for a given pre-detection interval to an expected carrier phase computed using a filtered frequency error estimate derived from in-phase and quadrature accumulations supplied by one or more signal source(s) (e.g., the signal sources(s) 202). When the difference between the expected carrier phase and the raw carrier phase exceeds a threshold consistent with a whole-cycle or half-cycle transition, the signal processing system may classify the observed deviation as a carrier phase rollover. In additional examples, when the signal processing system determines that the carrier tracking loop 204 temporarily lost lock or that the observed phase behavior cannot be reconciled with the filtered frequency error estimate, the signal processing system may classify the event as a cycle slip. Through detecting 300, the signal processing system may identify carrier phase discontinuities caused by oscillator-induced dynamics, signal fading, or other conditions that produce non-continuous phase evolution across successive pre-detection intervals.

In some embodiments, detecting 300 may include generating multiple candidate interpretations of an observed carrier phase change and selecting a candidate that aligns most closely with the filtered frequency error estimate. The signal processing system may generate a set of candidate phase differences by adding or subtracting one or more cycle-related increments to the raw carrier phase difference observed across a pre-detection interval. The signal processing system may then compare each candidate phase difference to the filtered frequency error estimate produced from in-phase and quadrature accumulations supplied by the signal source(s) 202. For example, when the signal processing system observes a raw carrier phase difference that exceeds a phase variation range consistent with expected carrier phase progression over the pre-detection interval, the signal processing system may evaluate candidate phase differences that incorporate whole-cycle or half-cycle adjustments and may select the candidate that exhibits the smallest deviation from the filtered frequency error estimate. In some configurations, detecting 300 may also include evaluating signal quality indicators, such as carrier-to-noise density ratios or lock status flags generated by the carrier tracking loop 204, to determine whether the observed raw carrier phase value should be considered reliable for discontinuity detection.

The method of FIG. 3 also includes compensating 302 the raw carrier phase based on an accumulation of each carrier phase discontinuity of the one or more carrier phase discontinuities. Compensating 302 may be carried out by the signal processing system by obtaining each carrier phase discontinuity identified during detecting 300 and updating an accumulated discontinuity value that reflects the total number of whole-cycle or half-cycle transitions detected across successive pre-detection intervals. For example, when detecting 300 determines that a carrier phase rollover has occurred, the signal processing system may increment or decrement an accumulated discontinuity count stored in memory and may maintain the accumulated discontinuity count for use in generating a compensated carrier phase during subsequent processing operations, as is further described herein. Through compensating 302, the signal processing system may adjust the raw carrier phase so that the resulting compensated carrier phase remains continuous and representative of the true phase progression despite temporary loss-of-lock conditions or oscillator-induced frequency excursions.

In some embodiments, compensating 302 may include maintaining an accumulated representation of each carrier phase discontinuity so that the accumulated representation can be used during subsequent processing to support generation of a compensated carrier phase, as is further described herein. The signal processing system may update the accumulated representation each time detecting 300 identifies a carrier phase rollover, and may store the accumulated representation for use in determining a compensated carrier phase at a selected output interval. For example, during periods of oscillator-induced dynamics, the accumulated representation may increase or decrease as additional discontinuities are detected across successive pre-detection intervals. In other embodiments, compensating 302 may further include verifying that the accumulated representation remains consistent with observed frequency behavior or signal quality indicators before the accumulated representation is used in generating a net compensated carrier phase.

The method of FIG. 3 also includes generating 304 a net compensated carrier phase including the compensation to the raw carrier phase. Generating 304 may be carried out by the signal processing system by using the accumulated representation of carrier phase discontinuities maintained during compensating 302 and producing a compensated carrier phase value for a selected output interval. For example, the signal processing system may obtain a raw carrier phase observation from the carrier tracking loop 204 at an established output interval and may generate a compensated carrier phase value based on the accumulated representation so that the resulting net compensated carrier phase reflects continuous phase progression across the pre-detection intervals associated with the output interval.

In some embodiments, generating 304 the net compensated carrier phase may include determining a compensated phase value by combining the raw carrier phase observed for a given measurement interval with the compensation determined from the accumulated representation of carrier phase discontinuities. The signal processing system may compute the net compensated carrier phase by adding or subtracting the number of cycles associated with the accumulated representation to or from the raw carrier phase and express the resulting value in a continuous phase domain that may not be subject to the periodicity of the carrier tracking loop. The signal processing system may further scale or normalize the compensated phase value using the carrier wavelength or an equivalent phase-to-range conversion factor so that the net compensated carrier phase can be utilized directly by downstream positioning engines or control systems. In additional embodiments, generating 304 may include associating the net compensated carrier phase with metadata such as a measurement-epoch index or confidence indicator, enabling downstream systems to incorporate the net compensated carrier phase into one or more adjustment operations while maintaining phase continuity across successive pre-detection intervals.

In some embodiments, generating 304 may include preparing the net compensated carrier phase for transmission to the carrier phase data interface 210 so that downstream positioning engines or real-time control components can utilize the compensated carrier phase for navigation or adjustment operations. In other embodiments, generating 304 may also include producing a compensated carrier phase that incorporates the accumulated representation of carrier phase discontinuities maintained during compensating 302. The signal processing system may retrieve the accumulated representation at an established output interval and may apply the accumulated representation to the raw carrier phase observed by the carrier tracking loop 204 so that the resulting compensated carrier phase can reflect continuous phase progression across the pre-detection intervals encompassed by the output interval. For example, during periods of oscillator-induced dynamics, the accumulated representation may increase or decrease as carrier phase rollovers are detected, and generating 304 may include using the accumulated representation to ensure that the compensated carrier phase remains consistent with the expected phase progression based on the filtered frequency error estimate and prior carrier phase information of the underlying signal phase. In some configurations, generating 304 may further include formatting or structuring the compensated carrier phase for transmission to the carrier phase data interface 210 so that downstream positioning engines or real-time control systems can utilize the compensated carrier phase in navigation or adjustment operations.

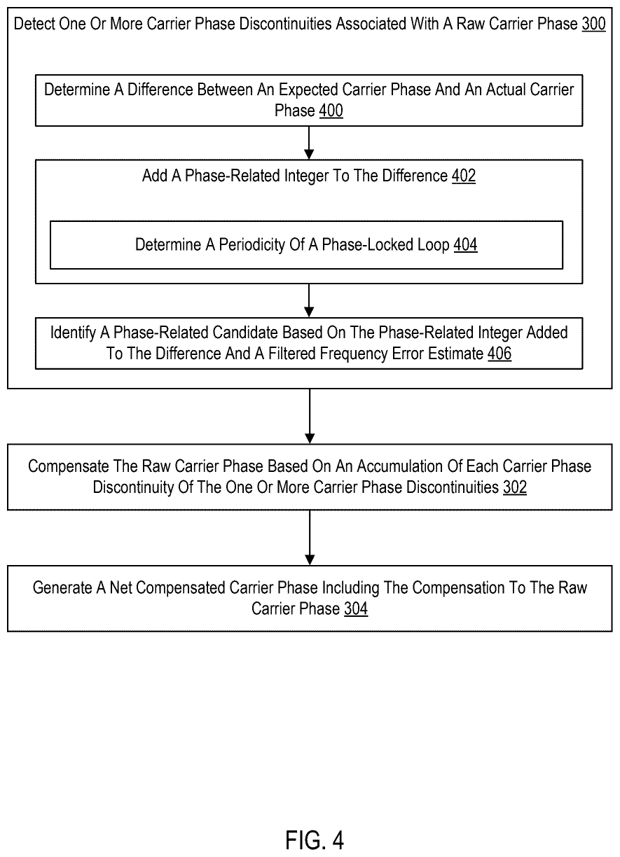

The method steps of FIG. 3 collectively describe how the signal processing system can detect one or more carrier phase discontinuities, maintain an accumulated representation of each detected discontinuity, and generate a net compensated carrier phase based on the accumulated representation. Detecting 300 enables the signal processing system to identify carrier phase rollovers, compensating 302 enables the signal processing system to adjust the raw carrier phase based on the accumulated representation of the detected discontinuities, and generating 304 enables the signal processing system to produce a net compensated carrier phase that may be utilized by downstream positioning engines or real-time control components. FIG. 4 further illustrates a flowchart that expands upon the method of FIG. 3 by describing how the signal processing system can determine a difference between an expected carrier phase and an actual carrier phase, add a phase-related integer to the difference, and identify a phase-related candidate based on the phase-related integer added to the difference and a filtered frequency error estimate in accordance with embodiments of the present disclosure.

For further explanation, FIG. 4 sets forth a flowchart illustrating an example method of determining a difference between an expected carrier phase and an actual carrier phase, adding a phase-related integer to the difference, and identifying a phase-related candidate in accordance with embodiments of the present disclosure. The example method of FIG. 4 can be carried out in a system similar to that of FIG. 2 and in consideration of a computing system, such as the computing system 100 illustrated in FIG. 1. In one or more embodiments, the method of FIG. 4 can be performed by a signal processing system that may be represented by the processor 104 illustrated as a component of the computing system 100.

The method of FIG. 4 includes determining 400 a difference between an expected carrier phase and an actual carrier phase. Determining 400 is part of detecting 300 the one or more carrier phase discontinuities of the method of FIG. 3 and may be carried out by the signal processing system by generating the expected carrier phase for a given pre-detection interval using a filtered frequency error estimate derived from in-phase and quadrature accumulations supplied by one or more signal source(s) (e.g., the signal source(s) 202) and by comparing the expected carrier phase to the actual carrier phase observed by a carrier tracking loop (e.g., the carrier tracking loop 204). For example, the signal processing system may propagate a prior carrier phase observation forward in time based on the filtered frequency error estimate to obtain the expected carrier phase and may subtract the expected carrier phase from the actual carrier phase to produce a phase difference suitable for use in identifying a phase-related candidate. In one or more examples, and at each pre-detection interval epoch k, a delta carrier phase may be computed as:

$$A φ ( k ) = φ ( k ) - φ ( k - 1 ) ,$$

where φ(k) represents a carrier phase observation for the current pre-detection interval and φ(k−1) represents a carrier phase observation from a prior pre-detection interval.

In some embodiments, determining 400 may include generating an expected carrier phase that incorporates a filtered frequency error estimate so that the expected carrier phase reflects the anticipated progression of the carrier phase across the corresponding pre-detection interval. The signal processing system may generate the filtered frequency error estimate by smoothing instantaneous frequency error values derived from in-phase and quadrature accumulations supplied by the signal source(s) 202, and may use the filtered frequency error estimate to propagate a prior carrier phase observation forward in time. In other embodiments, determining 400 may also include verifying that the actual carrier phase observed by the carrier tracking loop 204 remains within a deviation range consistent with a reliable raw carrier phase, as defined herein, based on the filtered frequency error estimate before computing the difference between the expected carrier phase and the actual carrier phase. For example, during periods of oscillator-induced dynamics, the filtered frequency error estimate may shift by an amount that exceeds a defined deviation tolerance, and determining 400 may include evaluating whether the filtered frequency error estimate remains consistent with other signal characteristics, such as carrier-to-noise density ratios or lock indicators, before generating the expected carrier phase. In further embodiments, determining 400 may additionally include structuring the calculated phase difference for subsequent processing stages, such as identifying a phase-related candidate in the adding 402 step of FIG. 4.

In the method of FIG. 4, detecting 300 also includes adding 402 a phase-related integer to the difference. Adding 402 may be carried out by the signal processing system by generating one or more integer-adjusted versions of the phase difference produced during determining 400 so that potential whole-cycle or half-cycle transitions can be evaluated. In one or more examples, when the carrier tracking loop operates with a full-cycle periodicity, a set of delta carrier phase rollover candidates may be expressed as:

$${Δ φ ( k )}_{vec} = [ Δ φ ( k ) , Δ φ ( k ) + 2 π , Δ φ ( k ) - 2 π ] ,$$

with corresponding cycle values:

$${Δ φ ( k )}_{vec \_ int} = [ 0 , + 1 , - 1 ] .$$

As another example, the signal processing system may add or subtract integer multiples of a carrier phase cycle, such as one full cycle or one half-cycle, to the phase difference to generate a set of adjusted phase difference values that each represent a possible interpretation of the observed carrier phase behavior.

In some embodiments, adding 402 may include generating candidate phase adjustments that correspond to positive or negative rotations that fall outside a phase variation range consistent with expected phase progression over the corresponding pre-detection interval, enabling the signal processing system to account for abrupt changes in carrier phase caused by oscillator-induced dynamics, signal fading, or temporary loss-of-lock conditions in the carrier tracking loop 204. In other embodiments, adding 402 may also include generating one or more phase-related integers that represent possible whole-cycle or half-cycle transitions associated with the observed carrier phase behavior. The signal processing system may generate these phase-related integers by identifying rotation increments consistent with the periodicity of the carrier tracking loop 204 and may prepare these integers for application to the phase difference produced during determining 400. In further embodiments, adding 402 may additionally include selecting a set of candidate phase-related integers that reflect phase transitions consistent with expected carrier phase progression for the corresponding pre-detection interval, such as ±1 cycle, ±½ cycle, or other loop-specific periodic increments. In one or more examples, when the carrier tracking loop operates with a half-cycle periodicity, a set of delta carrier phase rollover candidates may be expressed as:

$${Δ φ ( k )}_{vec} = [ Δ φ ( k ) , Δ ( k ) + π , Δ φ ( k ) - π ] ,$$

with corresponding half cycle values:

$${Δ ( k )}_{vec \_ int} = = [ 0 , + 0.5 , - 0.5 ] .$$

As another example, during periods of oscillator-induced dynamics or rapid frequency excursions, the range of integer adjustments consistent with expected carrier phase progression for the corresponding pre-detection interval may expand, and adding 402 may include evaluating signal quality indicators, such as carrier-to-noise density ratios or lock indicators, before generating the corresponding integer-adjusted phase differences. In other embodiments, adding 402 may also include structuring the integer-adjusted phase differences for subsequent processing stages, such as identifying 406 a phase-related candidate that most closely aligns with a filtered frequency error estimate in accordance with the method of FIG. 4.

In the method of FIG. 4, adding 402 also includes determining 404 a periodicity of a phase-locked loop. Determining 404 may be carried out by the signal processing system by identifying the periodic phase rotation characteristics associated with the carrier tracking loop 204 so that the signal processing system may ensure that the phase-related integers described as generated during adding 402 correspond to valid rollover increments. For example, the signal processing system may determine whether the carrier tracking loop 204 operates with a ±180-degree periodicity or with a ±90-degree periodicity based on the configuration of the discriminator of the loop.

In some embodiments, determining 404 may include referencing hardware configuration parameters or loop-type indicators to confirm the applicable periodicity before generating or selecting the phase-related integers used to adjust the phase difference. In other embodiments, determining 404 may enable the signal processing system to constrain the set of integer adjustments applied during adding 402 so that subsequent identification 406 of a phase-related candidate remains consistent with the operational behavior of the carrier tracking loop 204. In some embodiments, determining 404 may include evaluating additional characteristics of the carrier tracking loop 204 that influence the periodicity used to generate the phase-related integers during adding 402. The signal processing system may assess loop filter settings, discriminator configurations, or tracking mode indicators to confirm that the periodicity reflects the operational behavior of the carrier tracking loop 204 under current signal conditions. For example, when the carrier tracking loop 204 operates in a phase-locked loop configuration, determining 404 may include confirming that the loop is processing phase values within a ±180-degree range, whereas when the carrier tracking loop 204 operates with a ±90-degree periodicity, determining 404 may include confirming that the loop is constrained to a ±90-degree range. In further embodiments, determining 404 may additionally include establishing periodicity parameters that account for dynamic transitions between loop types, such as temporary changes in loop behavior during low signal strength or high-dynamics intervals. In additional configurations, determining 404 may include preparing the determined periodicity for subsequent processing stages so that identifying 406 a phase-related candidate remains consistent with the expected rotation bounds of the carrier tracking loop 204.

In the method of FIG. 4, detecting 300 also includes identifying 406 a phase-related candidate based on the phase-related integer added during adding 402 and a filtered frequency error estimate. Identifying 406 may be carried out by the signal processing system by comparing each integer-adjusted phase difference generated during adding 402 to the filtered frequency error estimate associated with the corresponding pre-detection interval and selecting the integer-adjusted phase difference that most closely aligns with the filtered frequency error estimate. In one or more examples, an unwrapped delta carrier phase may be selected as:

$${Δ φ ( k )}_{UW} = {Δ φ ( k )}_{vec} ( argmin ( \vert {Δ φ ( k )}_{vec} - \overline{Δ f ( k )} \vert ) ) ,$$

and a corresponding cycle value may be determined as

$$cycles = {Δ φ ( k )}_{vec \_ int} ( argmin ( \vert {Δ φ ( k )}_{vec} - \overline{Δ f ( k )} \vert ) ) ,$$

where Δ̅f̅(̅k̅)̅ represents a smoothed frequency error estimate for the current pre-detection interval.

As another example, the signal processing system may compute an error metric for each integer-adjusted phase difference and may identify the phase-related candidate as the integer-adjusted phase difference that exhibits the smallest deviation from the filtered frequency error estimate under the prevailing signal conditions.

In some embodiments, identifying 406 may include evaluating additional characteristics of the integer-adjusted phase differences generated during adding 402 to confirm that the selected phase-related candidate represents a valid interpretation of the underlying carrier phase behavior. The signal processing system may assess lock status indicators, carrier-to-noise density ratios, or discriminator metrics generated by the carrier tracking loop 204 to determine whether certain integer-adjusted phase differences should be excluded from consideration prior to identifying the phase-related candidate. In other embodiments, identifying 406 may also include applying threshold-based filters that remove integer-adjusted phase differences that deviate beyond a defined deviation tolerance relative to the filtered frequency error estimate, ensuring that the selected phase-related candidate may correspond to a phase transition consistent with expected carrier phase progression for the corresponding pre-detection interval under current signal conditions. For example, during periods of low signal strength or rapid frequency change, identifying 406 may include enforcing alignment criteria using a reduced tolerance value for deviation between each integer-adjusted phase difference and the filtered frequency error estimate to prevent the selection of integer-adjusted phase differences that exceed a deviation tolerance relative to the filtered frequency error estimate. In additional configurations, identifying 406 may further include preparing the identified phase-related candidate for subsequent processing stages, as is further described herein.

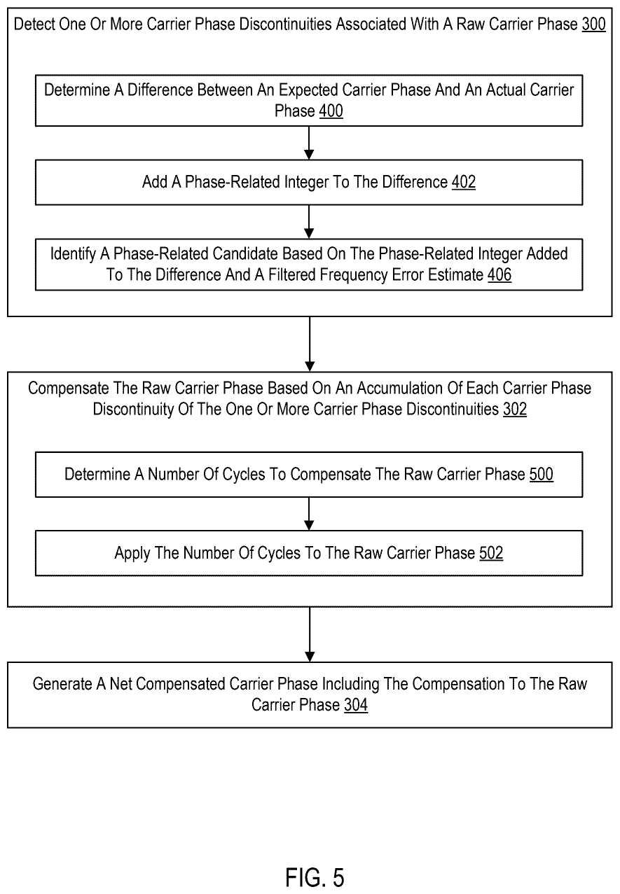

The method steps of FIG. 4 collectively describe how the signal processing system can determine a difference between an expected carrier phase and an actual carrier phase, add a phase-related integer to the difference based on loop-specific periodicity, and identify a phase-related candidate that reflects an interpretation consistent with expected carrier phase behavior for the corresponding pre-detection interval as part of detecting 300 the one or more carrier phase discontinuities of FIG. 3. Determining 400 enables the signal processing system to compute a phase difference suitable for further analysis, adding 402 enables the signal processing system to apply a phase-related integer to the phase difference in accordance with the operational periodicity of the carrier tracking loop 204, and identifying 406 enables the signal processing system to select the phase-related candidate that most closely aligns with the corresponding filtered frequency error estimate. The identified phase-related candidate may be used during compensating 302 to support adjustment of the raw carrier phase based on the accumulated representation of carrier phase discontinuities and during generating 304 to support production of a net compensated carrier phase as described with reference to FIG. 3. FIG. 5 further illustrates a flowchart that expands upon the method of FIG. 4 by describing how the signal processing system can determine a number of cycles to compensate the raw carrier phase and apply the number of cycles to the raw carrier phase in accordance with embodiments of the present disclosure.

For further explanation, FIG. 5 sets forth a flowchart illustrating an example method of determining a number of cycles to compensate a raw carrier phase and applying the number of cycles to the raw carrier phase in accordance with embodiments of the present disclosure. The example method of FIG. 5 can be carried out in a system similar to that of FIG. 2 and in consideration of a computing system, such as the computing system 100 illustrated in FIG. 1. In one or more embodiments, the method of FIG. 5 can be performed by a signal processing system that may be represented by the processor 104 illustrated as a component of the computing system 100.

In the method of FIG. 5, compensating 302 includes determining 500 a number of cycles to compensate the raw carrier phase based on identifying 406 the phase-related candidate and an accumulated representation of carrier phase discontinuities. Operations associated with detecting 300 the one or more carrier phase discontinuities, including determining 400, adding 402, and identifying 406, as described with reference to FIGS. 3 and 4, may provide the signal processing system with one or more inputs used during determining 500. Determining 500, which is part of compensating 302, may then be carried out by the signal processing system by combining the phase-related candidate with the accumulated representation of carrier phase discontinuities so that the resulting number of cycles reflects the total whole-cycle or half-cycle transitions associated with the raw carrier phase.

In one or more examples, the cycle values determined for each pre-detection interval may be accumulated across successive pre-detection intervals and applied to compensate a carrier phase measurement generated at a measurement generation interval. In addition, the selected un wrapped delta carrier phase Δφ(k)_{UW} may be incorporated into a smoothed unwrapped delta carrier phase, which may be used in subsequent carrier phase discontinuity detection or carrier phase compensation operations.

In some embodiments, determining 500 may include evaluating whether the phase-related candidate identified during identifying 406 represents a whole-cycle or half-cycle transition for the corresponding pre-detection interval. The signal processing system may assess the magnitude and direction of the phase-related candidate and may determine how the phase-related candidate influences the accumulated representation of carrier phase discontinuities. In other embodiments, determining 500 may also include generating an intermediate cycle count that combines the phase-related candidate with previously detected discontinuities so that the number of cycles reflects cumulative phase transitions across multiple pre-detection intervals. For example, during periods of oscillator-induced dynamics or rapid frequency excursions, determining 500 may include confirming that the intermediate cycle count aligns with trends observed in filtered frequency error estimates or other signal-quality metrics. In further embodiments, determining 500 may additionally include preparing the number of cycles for subsequent processing stages, as is further described herein.

In the method of FIG. 5, compensating 302 also includes applying 502 the number of cycles to the raw carrier phase. Applying 502 may be carried out by the signal processing system by adjusting the raw carrier phase observed by the carrier tracking loop 204 using the number of cycles determined during determining 500. For example, the signal processing system may add or subtract the number of cycles to the raw carrier phase in accordance with the sign and magnitude of the cycle count so that the resulting carrier phase value reflects the continuous phase progression associated with the underlying signal. In some embodiments, applying 502 may include storing the compensated carrier phase for use in generating 304 the net compensated carrier phase at a selected output interval as described with reference to FIG. 3.

In some embodiments, applying 502 may include converting the number of cycles determined during determining 500 into a phase adjustment value that corresponds to the carrier wavelength of the signal so that the raw carrier phase can be updated in units consistent with the underlying tracking architecture. The signal processing system may add the phase adjustment value to the raw carrier phase observed by the carrier tracking loop 204 to generate an updated carrier phase that reflects the cumulative cycle transitions detected across multiple pre-detection intervals. In other embodiments, applying 502 may also include validating the compensated carrier phase against filtered frequency error estimates or carrier-to-noise density ratios to confirm that the applied cycle adjustment remains consistent with expected phase behavior for the corresponding satellite signal. For example, during periods of degraded signal quality or oscillator-induced variations that exceed a defined deviation tolerance, applying 502 may include enforcing bounds on the compensated carrier phase to mitigate adjustments that exceed a defined deviation tolerance associated with unreliable discontinuity detections. In additional configurations, applying 502 may include preparing the compensated carrier phase for subsequent operations, such as generating 304 the net compensated carrier phase as described with reference to FIG. 3.

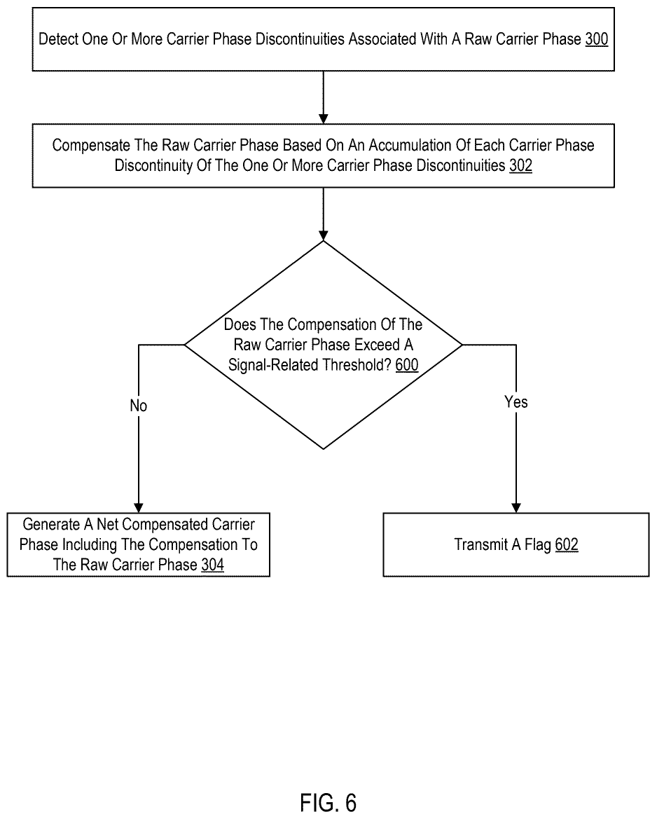

The method steps of FIG. 5 collectively describe how the signal processing system can determine a number of cycles to compensate the raw carrier phase and apply the number of cycles to the raw carrier phase as part of compensating 302 the raw carrier phase. Determining 500 enables the signal processing system to compute a cycle count that reflects whole-cycle or half-cycle transitions identified during detecting 300, and applying 502 enables the signal processing system to update the raw carrier phase in accordance with the computed cycle count so that the compensated carrier phase reflects continuous phase progression across successive pre-detection intervals. The number of cycles applied during applying 502 may be used during generating 304 to support production of a net compensated carrier phase for downstream positioning or real-time adjustment operations. FIG. 6 further illustrates a flowchart that expands upon the method of FIG. 5 by describing how the signal processing system can determine whether the compensation of the raw carrier phase exceeds a signal-related threshold and transmit a flag in accordance with embodiments of the present disclosure.

For further explanation, FIG. 6 sets forth a flowchart illustrating an example method of determining whether compensation of a raw carrier phase exceeds a signal-related threshold and transmitting a flag in accordance with embodiments of the present disclosure. The example method of FIG. 6 can be carried out in a system similar to that of FIG. 2 and in consideration of a computing system, such as the computing system 100 illustrated in FIG. 1. In one or more embodiments, the method of FIG. 6 can be performed by a signal processing system that may be represented by the processor 104 illustrated as a component of the computing system 100.

The method of FIG. 6 includes determining 600 whether the compensation of the raw carrier phase exceeds a signal-related threshold. Operations associated with detecting 300 the one or more carrier phase discontinuities and compensating 302 the raw carrier phase based on an accumulation of each carrier phase discontinuity, as illustrated in FIG. 6 and described with reference to FIGS. 3-5, may provide the signal processing system with the compensated carrier phase and signal-level information used during determining 600. Determining 600 may be carried out by the signal processing system by evaluating whether the magnitude of the compensation applied to the raw carrier phase during compensating 302 exceeds a threshold associated with a defined deviation or signal-quality metric of the raw carrier phase or with a signal level of the corresponding satellite measurement. For example, the signal processing system may compare the amount of compensation applied to a threshold derived from carrier-to-noise density ratios, lock status indicators, or amplitude consistency measures to determine whether the compensation reflects a condition indicative of unreliable carrier phase behavior.

In some embodiments, determining 600 may include evaluating whether the compensation applied to the raw carrier phase exceeds a predefined tolerance associated with expected signal behavior for a particular satellite or tracking channel. The signal processing system may compare the compensated carrier phase generated during compensating 302 to historical compensation values or to statistical bounds derived from previous pre-detection intervals to determine whether the applied compensation exceeds a compensation-magnitude threshold associated with the corresponding satellite signal. In other embodiments, determining 600 may also include applying threshold criteria that account for signal degradation, such as reduced carrier-to-noise density ratios or abnormal variations in the filtered frequency error estimate, to determine whether the compensation reflects conditions associated with an unreliable raw carrier phase, as defined herein. For example, during periods of low signal strength or increased oscillator-induced dynamics, determining 600 may include enforcing thresholds defined by a reduced deviation or compensation tolerance so that compensation values indicative of conditions associated with an unreliable raw carrier phase, as defined herein, can be detected. In further embodiments, determining 600 may additionally include preparing the result of the threshold comparison for subsequent processing stages, such as transmitting 602 a flag to downstream systems in response to determining that the compensation of the raw carrier phase exceeds the signal-related threshold, as is further described herein.

In the method of FIG. 6, determining 600 also includes transmitting 602 a flag in response to determining that the compensation of the raw carrier phase exceeds the signal-related threshold. Transmitting 602 may be carried out by the signal processing system by generating a flag that indicates the presence of unreliable carrier phase behavior and providing the flag to the carrier phase data interface 210 for use by downstream positioning engines or real-time control components. For example, when determining 600 identifies that the applied compensation exceeds the signal-related threshold due to abrupt frequency variations or conditions associated with an unreliable raw carrier phase, as defined herein, the signal processing system may transmit the flag so that external systems can exclude or down-weight the compensated carrier phase in navigation or adjustment operations.

In some embodiments, transmitting 602 may include formatting the flag in accordance with an interface specification associated with the carrier phase data interface 210 so that downstream systems can correctly interpret the indication that compensation of the raw carrier phase exceeds the signal-related threshold. The signal processing system may associate the flag with metadata such as a timestamp, a satellite identifier, or a measurement-epoch index to assist downstream positioning engines or real-time control components in determining how the corresponding carrier phase measurement should be treated. In other embodiments, transmitting 602 may also include queuing the flag for asynchronous delivery when the carrier phase data interface 210 operates under reduced throughput conditions or batching multiple flags when several measurement epochs exceed the signal-related threshold. For example, during periods of degraded tracking performance, transmitting 602 may include aggregating multiple flags to reduce communication overhead while preserving an indication of each flagged event. In further embodiments, transmitting 602 may additionally include notifying downstream navigation systems that a net compensated carrier phase will not be generated for the flagged measurement epoch so that downstream systems can disregard the affected carrier phase in positioning or adjustment operations.

In the method of FIG. 6, determining 600 also includes proceeding with generating 304 a net compensated carrier phase in an instance wherein the compensation of the raw carrier phase does not exceed the signal-related threshold. Generating 304 may be carried out by the signal processing system by using the compensated carrier phase produced during compensating 302 so that a net compensated carrier phase is generated for subsequent use by downstream positioning engines or real-time control components, as is described with reference to FIG. 3. In this manner, generating 304 is performed only when determining 600 identifies that the applied compensation remains within bounds defined by the signal-related threshold for the corresponding measurement interval for the corresponding satellite signal.

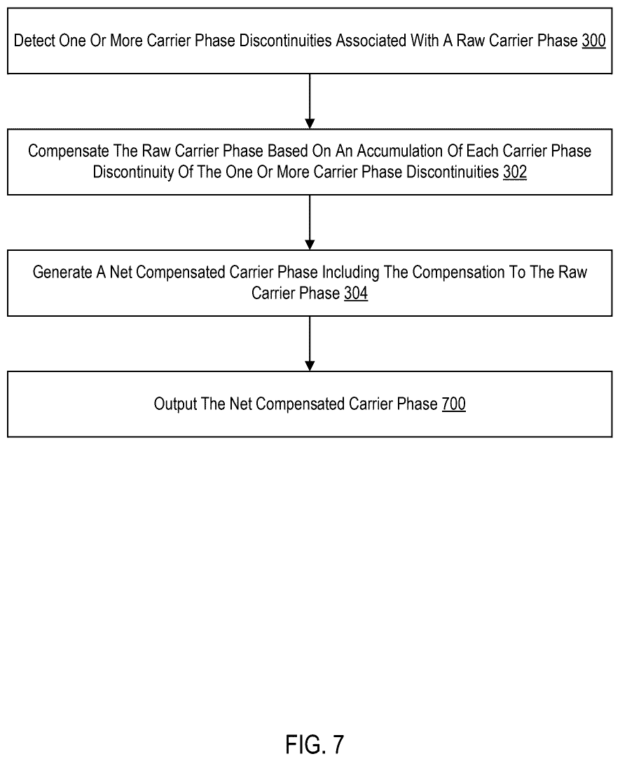

The method steps of FIG. 6 collectively describe how the signal processing system can determine whether compensation of the raw carrier phase exceeds a signal-related threshold and respond accordingly as part of generating 304 the net compensated carrier phase. Detecting 300 enables the signal processing system to identify carrier phase discontinuities, compensating 302 enables the signal processing system to adjust the raw carrier phase based on the accumulated representation of those discontinuities, and generating 304 enables the signal processing system to produce a net compensated carrier phase when the compensation remains within bounds defined by the signal-related threshold for the corresponding measurement interval. Determining 600 provides a mechanism for evaluating whether the magnitude of the applied compensation indicates unreliable carrier phase behavior, and transmitting 602 enables the signal processing system to notify downstream systems when the threshold is exceeded so that the corresponding compensated carrier phase can be disregarded. FIG. 7 further illustrates a flowchart that expands upon the method of FIG. 6 by describing how the signal processing system can output the net compensated carrier phase in accordance with embodiments of the present disclosure.

For further example, FIG. 7 sets forth a flowchart illustrating an example method of outputting a net compensated carrier phase in accordance with embodiments of the present disclosure. The example method of FIG. 7 can be carried out in a system similar to that of FIG. 2 and in consideration of a computing system, such as the computing system 100 illustrated in FIG. 1. In one or more embodiments, the method of FIG. 7 can be performed by a signal processing system that may be represented by the processor 104 illustrated as a component of the computing system 100.

The method of FIG. 7 includes outputting 700 the net compensated carrier phase. Operations associated with detecting 300 the one or more carrier phase discontinuities, compensating 302 the raw carrier phase based on an accumulation of each carrier phase discontinuity, and generating 304 the net compensated carrier phase, as described with reference to FIGS. 3-6, may provide the signal processing system with the net compensated carrier phase used during outputting 700. Outputting 700 may be carried out by the signal processing system by providing the net compensated carrier phase to the carrier phase data interface 210 so that downstream positioning engines, navigation algorithms, or real-time control components can incorporate the net compensated carrier phase into corresponding operations.

In some embodiments, outputting 700 may include preparing the net compensated carrier phase in a format suitable for use by downstream positioning engines or real-time navigation components. The signal processing system may associate the net compensated carrier phase with measurement-epoch metadata, such as a timestamp or satellite identifier, to enable downstream systems to integrate the compensated phase into precise positioning or estimation routines. In other embodiments, outputting 700 may also include transmitting the net compensated carrier phase through the carrier phase data interface 210 using a structured data format that supports high-resolution carrier phase values, allowing downstream systems to incorporate the compensated phase directly into carrier-phase-based calculations. For example, during continuous tracking operations, outputting 700 may include providing the net compensated carrier phase at a fixed output interval to support real-time tracking loops or Kalman filter updates. In further embodiments, outputting 700 may additionally include selecting a priority or delivery mode that aligns with the requirements of a downstream consumer, such as immediate delivery to a navigation module when rapid carrier phase updates are required for high-dynamics operation.

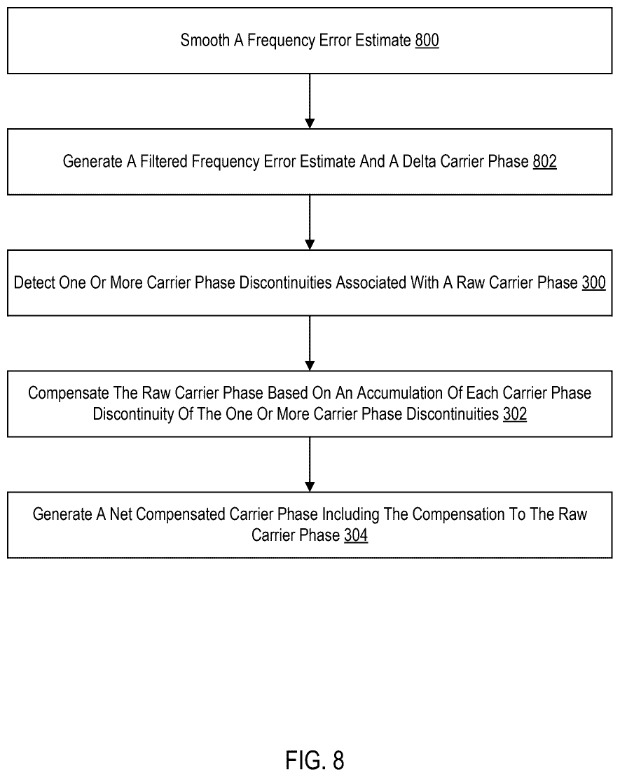

The method steps of FIG. 7 collectively describe how the signal processing system can output the net compensated carrier phase that results from detecting 300 one or more carrier phase discontinuities, compensating 302 the raw carrier phase based on an accumulated representation of the detected discontinuities, and generating 304 the net compensated carrier phase for a selected measurement interval. Detecting 300 enables the signal processing system to identify carrier phase rollovers, compensating 302 enables the signal processing system to incorporate the accumulated representation of those discontinuities into the raw carrier phase, and generating 304 enables the signal processing system to produce a continuous carrier phase value suitable for downstream use. Outputting 700 enables the signal processing system to provide the resulting net compensated carrier phase to downstream positioning engines or real-time control components for navigation or adjustment operations. FIG. 8 further illustrates a flowchart that expands upon the methods of FIGS. 3-7 by describing how the signal processing system can smooth a frequency error estimate and generate a filtered frequency error estimate and a delta carrier phase in accordance with embodiments of the present disclosure.

For further explanation, FIG. 8 sets forth a flowchart illustrating an example method of smoothing a frequency error estimate and generating a filtered frequency error estimate and a delta carrier phase in accordance with embodiments of the present disclosure. The example method of FIG. 8 can be carried out in a system similar to that of FIG. 2 and in consideration of a computing system, such as the computing system 100 illustrated in FIG. 1. In one or more embodiments, the method of FIG. 8 can be performed by a signal processing system that may be represented by the processor 104 illustrated as a component of the computing system 100.

The method of FIG. 8 includes smoothing 800 a frequency error estimate. Smoothing 800 may be carried out by the signal processing system by applying one or more filtering techniques to reduce noise present in the instantaneous frequency error estimate observed for each pre-detection interval. For example, the signal processing system may apply a low-pass or exponential smoothing filter to stabilize the frequency error estimate across successive pre-detection intervals to produce values suitable for generating 802 a filtered frequency error estimate and a delta carrier phase.

In some embodiments, smoothing 800 may include selecting a smoothing factor that can balance responsiveness to rapid phase or frequency changes with resistance to noise fluctuations present in the instantaneous measurements. The signal processing system may determine the smoothing factor based on observed characteristics of the incoming satellite signal, such as variations in carrier-to-noise density ratios, discriminator stability, or recent trends in the instantaneous frequency error estimate. In other embodiments, smoothing 800 may include applying separate smoothing parameters to the instantaneous frequency error estimate so that each quantity is filtered according to its respective noise sensitivity. For example, during periods of oscillator-induced dynamics that exceed a defined deviation tolerance, smoothing 800 may include applying a smoothing operation with an increased smoothing coefficient to the instantaneous frequency error estimate to suppress short-term fluctuations. In additional configurations, smoothing 800 may further include preparing the resulting smoothed values for subsequent processing stages, as is further described herein.

The method of FIG. 8 also includes generating 802 a filtered frequency error estimate and a delta carrier phase. Generating 802 may be carried out by the signal processing system by using the smoothed frequency error estimate produced during smoothing 800 to derive stabilized values suitable for subsequent carrier phase processing operations. For example, the signal processing system may compute a delta carrier phase by determining the phase change between successive pre-detection intervals, and may refine the delta carrier phase using the smoothed frequency error estimate to generate a filtered frequency error estimate that reflects the underlying signal dynamics more accurately than the instantaneous measurements.

In some embodiments, generating 802 may include refining the delta carrier phase by evaluating the consistency between the phase change derived from the smoothed frequency error estimate. The signal processing system may assess whether the delta carrier phase aligns with expected frequency behavior over the corresponding pre-detection interval and may adjust the delta carrier phase when deviations suggest noise levels that exceed a defined deviation tolerance or transient disturbances. In other embodiments, generating 802 may also include filtering the smoothed frequency error estimate using a model of anticipated oscillator dynamics or expected satellite motion so that the resulting filtered frequency error estimate can capture the longer-term frequency trend while suppressing short-term fluctuations. For example, during intervals with rapid thermal variations or user-induced motion, generating 802 may include applying more stringent refinement criteria to ensure that the filtered frequency error estimate accurately represents the dominant frequency behavior. In further embodiments, generating 802 may additionally include preparing the filtered frequency error estimate and the delta carrier phase for use in subsequent discontinuity detection or carrier phase compensation operations performed in accordance with methods described with reference to FIGS. 3-7.

In some embodiments, the delta carrier phase generated during generating 802 may assist the signal processing system in identifying carrier phase discontinuities during detecting 300. The delta carrier phase may represent the phase change between successive pre-detection intervals and may be compared to the filtered frequency error estimate or expected carrier phase progression to determine whether the observed phase change is consistent with reliable raw carrier phase behavior. When the delta carrier phase deviates beyond a defined deviation tolerance, the deviation may indicate the presence of a rollover or a potential cycle slip, and the signal processing system may incorporate the delta carrier phase as an input to the operations described with reference to determining 400, adding 402, and identifying 406. In this manner, the delta carrier phase may serve as a supporting metric that enhances the robustness of detecting 300 without altering the sequence of method steps described herein.

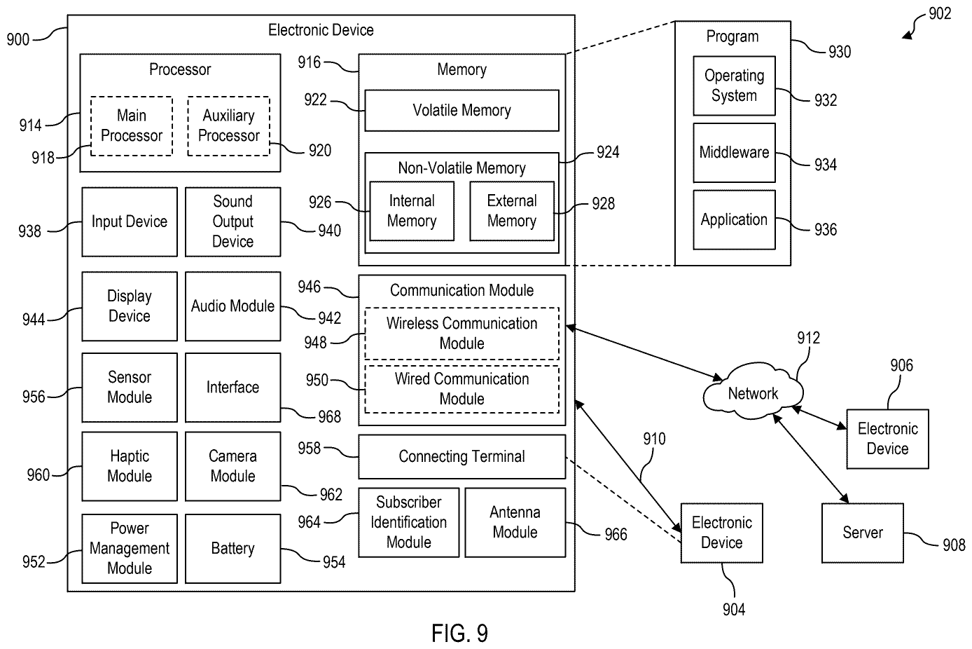

The method steps of FIG. 8 collectively describe how the signal processing system can smooth a frequency error estimate and generate a filtered frequency error estimate for use in carrier phase processing operations. Smoothing 800 enables the signal processing system to stabilize the instantaneous frequency error estimate across successive pre-detection intervals, and generating 802 enables the signal processing system to produce refined frequency and phase metrics suitable for integration into the broader carrier phase processing methods described with reference to FIGS. 3-7. These operations may support detecting 300 carrier phase discontinuities, compensating 302 the raw carrier phase, and generating 304 the net compensated carrier phase during execution of the methods described herein. In particular, the filtered frequency error estimate and the delta carrier phase generated during generating 802 may be used by the signal processing system during detecting 300 and subsequent processing stages to improve discontinuity detection accuracy, refine cycle accumulation during compensating 302, and support generation 304 of a continuous net compensated carrier phase. FIG. 9 further illustrates an example electronic device and network environment suitable for implementing the methods of FIGS. 1-8 in accordance with embodiments of the present disclosure.

FIG. 9 is a block diagram of an electronic device 900 in a network environment 902 in accordance with embodiments of the present disclosure. The electronic device 900 may operate independently or in conjunction with one or more other electronic devices 904 or 906, or a server 908, through a first network 910 (e.g., a short-range communication network) or a second network 912 (e.g., a long-range communication network). The electronic device 900 may correspond to, or include, the functional components of the computing system 100 or the carrier phase processing architecture 200 described with reference to FIGS. 1 and 2. For example, the electronic device 900 may execute one or more functionalities associated with the processor 104, the carrier tracking loop 204, the carrier phase monitoring module 206, and the rollover/discontinuity compensation module 208 to perform one or more operations associated with carrier phase processing, including the method steps described with reference to FIGS. 3-8.

Referring to FIG. 9, the components of the electronic device 900 illustrated therein will now be described in additional detail. These components may collectively enable the electronic device 900 to execute the systems and methods associated with carrier phase processing described throughout this disclosure. While particular components are shown in FIG. 9, additional or alternative components may be included in other embodiments, and the described components may be implemented as discrete hardware modules, integrated circuits, or combinations thereof.

A processor 914 may control overall operation of the electronic device 900 and execute instructions stored in a memory 916 to perform carrier phase processing operations. The processor 914 may include a main processor 918 and an auxiliary processor 920 that can operate independently or cooperatively to manage computational and communication tasks associated with carrier tracking, phase monitoring, discontinuity detection, cycle compensation, and net carrier phase generation. The main processor 918 may execute high-level operations associated with at least detecting 300 carrier phase discontinuities, compensating 302 the raw carrier phase, and generating 304 a net compensated carrier phase. The auxiliary processor 920 may perform specialized functions, such as generating 802 a filtered frequency error estimate and a delta carrier phase, smoothing 800 frequency error and phase measurements, or evaluating threshold conditions associated with determining 600. In some embodiments, the auxiliary processor 920 may remain active while the main processor 918 operates in a reduced-power state, maintaining continuous tracking of satellite signals and processing carrier phase data across successive pre-detection intervals.

The memory 916 may include both volatile memory 922 and non-volatile memory 924 configured to store data and instructions used by the processor 914 during operation of the electronic device 900. The non-volatile memory 924 may include internal memory 926 and external memory 928 that may store persistent datasets, software modules, and configuration parameters used for carrier tracking, frequency error estimation, discontinuity detection, and compensation routines. The memory 916 may also store a program 930 that may include an operating system 932, middleware 934, and one or more applications 936 executed by the processor 914 to perform operations associated with at least detecting 300, determining 400 phase differences, adding 402 phase-related integers, identifying 406 phase-related candidates, determining 500 cycle counts, applying 502 those counts to the raw carrier phase, and generating 304 a net compensated carrier phase. In some embodiments, the memory 916 may also maintain historical carrier phase values, filtered frequency error estimates, and accumulated discontinuity representations used to support real-time carrier phase processing in dynamic operating environments.

An input device 938 may receive user input, control parameters, or configuration data during operation of the electronic device 900. The input device 938 may include a touchscreen, keyboard, mouse, keypad, or other interface mechanisms that allow a user or system administrator to modify carrier phase processing parameters, adjust smoothing coefficients associated with smoothing 800, or configure threshold values associated with determining 600. In some embodiments, the input device 938 may also provide interfaces for defining tracking modes, selecting satellite systems to monitor, or initiating diagnostic operations associated with carrier tracking loop 204 performance. The input device 938 may further support firmware-level inputs that define operational tolerances used during cycle compensation or discontinuity detection.

A sound output device 940 may output audio signals generated by the electronic device 900. The sound output device 940 may include one or more speakers, receivers, or other audio transducers configured to provide system notifications, alerts, or operational feedback during carrier phase processing. In some embodiments, the sound output device 940 may emit alerts indicating tracking-status changes, such as detection of a carrier phase rollover during detecting 300, determination that compensation exceeds a signal-related threshold during determining 600, or successful output of a net compensated carrier phase during outputting 700. The sound output device 940 may operate in conjunction with an audio module 942 to enable audio-based diagnostics or alerting in signal-processing environments. For example, during extended carrier phase processing operation, the audio module 942 may produce distinct tones or voice prompts corresponding to different processing stages, such as smoothing 800, generating 802, or identifying 406 a phase-related candidate, allowing operators to monitor performance of the electronic device 900 without a visual indicator.

A display device 944 may visually present information generated by the processor 914 to a user of the electronic device 900. The display device 944 may include a flat-panel display, touchscreen, or projection-based display configured to render graphical interfaces and data visualizations related to carrier tracking and phase processing. In some embodiments, the display device 944 may present real-time carrier phase values, filtered frequency error estimates generated during generating 802, delta carrier phase values, discontinuity detection events associated with detecting 300, or threshold evaluations associated with determining 600. The display device 944 may further provide dashboards depicting signal strength, loop lock indicators, or status information related to cycle compensation operations.

A communication module 946 may enable the electronic device 900 to transmit and receive data through the first network 910 or the second network 912. The communication module 946 may include a wireless communication module 948 and a wired communication module 950, which may operate independently or cooperatively to support real-time transmission of carrier phase data, filtered frequency error estimates, cycle compensation values, and flags generated during transmitting 602. In one or more embodiments, the communication module 946 may exchange carrier phase measurements or processing outputs with other electronic devices 904, 906, or with the server 908 to support distributed navigation, sensor fusion, or cloud-based GNSS processing architectures.

A power management module 952 may regulate power distribution and consumption among the components of the electronic device 900. The power management module 952 may monitor voltage and current supplied to the processor 914, the memory 916, the communication module 946, and other subsystems to ensure stable operation during carrier phase tracking and signal processing. A battery 954 may provide electrical power to one or more of these components and may maintain continuous operation of the electronic device 900 during mobile or remote deployments. In some embodiments, the battery 954 may preserve carrier tracking state information, accumulated discontinuity representations, and filtered frequency error estimates during temporary power interruptions.

A sensor module 956 may detect operational, environmental, or performance-related conditions within the electronic device 900 and generate corresponding data signals for processing by the processor 914. The sensor module 956 may include temperature sensors, acceleration sensors, or RF quality monitors that influence smoothing 800 parameters, threshold values used during determining 600, or discontinuity detection sensitivity associated with detecting 300. The sensor module 956 may also track device orientation or thermal changes that affect oscillator stability, enabling dynamic adaptation of frequency error smoothing or compensation logic.

A connecting terminal 958 may include one or more physical connectors that enable the electronic device 900 to interface with external systems or peripheral devices. The connecting terminal 958 may support high-speed data transfer standards such as USB, PCIe, or serial interfaces to facilitate exchange of carrier phase data, filtered estimates, or diagnostic information. In some embodiments, the connecting terminal 958 may support debugging or calibration tools used to verify loop lock behavior or compensation accuracy.

A haptic module 960 may provide tactile feedback to a user of the electronic device 900 during operation. For example, the haptic module 960 may generate vibrational feedback when the signal processing system detects one or more carrier phase discontinuities during detecting 300, when the compensation surpasses a threshold during determining 600, or when a net compensated carrier phase is successfully output during outputting 700.

A camera module 962 may capture still images or video for diagnostics, environmental awareness, or device state verification. In some embodiments, the camera module 962 may capture visual indicators or hardware states associated with antenna performance, thermal conditions, or environmental factors that affect GNSS signal reception and may pass diagnostic results to the processor 914 or communication module 946.

A subscriber identification module 964 may store authentication credentials or identification data used by the communication module 946 to access secure networks or remote navigation servers. An antenna module 966 may enable wireless reception and transmission of signals, including GNSS signals used for carrier tracking and downlink communication with other devices or servers. An interface 968 may support communication and data exchange between the electronic device 900 and external peripherals, systems, or networks.

FIG. 9 therefore illustrates an example electronic device 900 and network environment 902 that can implement the systems and methods for carrier phase processing described with reference to FIGS. 3-8. The arrangement of components shown in FIG. 9 provides the hardware foundation for carrying out any of the method steps described herein.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
detecting, by a signal processing system, one or more carrier phase discontinuities associated with a raw carrier phase;
compensating, by the signal processing system, the raw carrier phase based on an accumulation of each carrier phase discontinuity of the one or more carrier phase discontinuities; and
generating, by the signal processing system, a net compensated carrier phase including the compensation to the raw carrier phase.

2. The method of claim 1, wherein the one or more carrier phase discontinuities includes at least one of a carrier phase rollover.

3. The method of claim 1, wherein detecting the one or more carrier phase discontinuities further comprises:
determining, by the signal processing system, a difference between an expected carrier phase and an actual carrier phase.

4. The method of claim 3, wherein detecting the one or more carrier phase discontinuities further comprises:
adding, by the signal processing system, a phase-related integer to the difference; and
identifying, by the signal processing system, a phase-related candidate based on the phase-related integer added to the difference and a filtered frequency error estimate.

5. The method of claim 4, wherein adding the phase-related integer to the difference further comprises:
determining, by the signal processing system, a periodicity of a phase-locked loop, wherein the phase-related integer corresponds to the periodicity of the phase-locked loop.

6. The method of claim 4, wherein compensating the raw carrier phase further comprises:
determining, by the signal processing system, a number of cycles to compensate the raw carrier phase based on identifying the phase-related candidate and the accumulation of each carrier phase discontinuity of the one or more carrier phase discontinuities; and
applying, by the signal processing system, the number of cycles to the raw carrier phase.

7. The method of claim 1, further comprising:
determining, by the signal processing system, whether the compensation of the raw carrier phase exceeds a signal-related threshold associated with at least one of a size of the raw carrier phase and a signal level of the raw carrier phase; and
transmitting, by the signal processing system, a flag in response to determining that the compensation of the raw carrier phase exceeds the signal-related threshold.

8. The method of claim 1, further comprising:
outputting, by the signal processing system, the net compensated carrier phase.

9. The method of claim 1, further comprising:
smoothing, by the signal processing system, a frequency error estimate; and
generating, by the signal processing system and in response to smoothing the frequency error estimate, a filtered frequency error estimate and a delta carrier phase, wherein the one or more carrier phase discontinuities associated with the raw carrier phase is detected using at least one of the filtered frequency error estimate and the delta carrier phase.

10. An apparatus comprising a computer processor, a computer memory operatively coupled to the computer processor, the computer memory having disposed within it computer program instructions that, when executed by the computer processor, cause the apparatus to carry out the steps of:
detecting one or more carrier phase discontinuities associated with a raw carrier phase;
compensating the raw carrier phase based on an accumulation of each carrier phase discontinuity of the one or more carrier phase discontinuities; and
generating a net compensated carrier phase including the compensation to the raw carrier phase.

11. The apparatus of claim 10, wherein the one or more carrier phase discontinuities includes at least one of a carrier phase rollover.

12. The apparatus of claim 10, wherein the computer program instructions caused to detect the one or more carrier phase discontinuities further cause the apparatus to carry out the step of:
determining a difference between an expected carrier phase and an actual carrier phase, wherein detecting the one or more carrier phase discontinuities is based on the difference.

13. The apparatus of claim 12, wherein the computer program instructions caused to detect the one or more carrier phase discontinuities further cause the apparatus to carry out the steps of:
adding a phase-related integer to the difference; and
identifying a phase-related candidate based on the phase-related integer added to the difference and a filtered frequency error estimate.

14. The apparatus of claim 13, wherein the computer program instructions caused to add the phase-related integer to the difference further cause the apparatus to carry out the steps of:
determining a periodicity of a phase-locked loop, wherein the phase-related integer corresponds to the periodicity of the phase-locked loop.

15. The apparatus of claim 13, wherein the computer program instructions caused to compensate the raw carrier phase further cause the apparatus to carry out the steps of:
determining a number of cycles to compensate the raw carrier phase based on identifying the phase-related candidate and the accumulation of each carrier phase discontinuity of the one or more carrier phase discontinuities; and
applying the number of cycles to the raw carrier phase.

16. The apparatus of claim 10, wherein the computer program instructions further cause the apparatus to carry out the steps of:
determining whether the compensation of the raw carrier phase exceeds a signal-related threshold associated with at least one of a size of the raw carrier phase and a signal level of the raw carrier phase; and
transmitting a flag in response to determining that the compensation of the raw carrier phase exceeds the signal-related threshold.

17. The apparatus of claim 10, wherein the computer program instructions further cause the apparatus to carry out the step of:
outputting the net compensated carrier phase.

18. The apparatus of claim 10, wherein the computer program instructions further cause the apparatus to carry out the steps of:
smoothing a frequency error estimate; and
generate, in response to smoothing the frequency error estimate, a filtered frequency error estimate and a delta carrier phase, wherein the one or more carrier phase discontinuities associated with the raw carrier phase is detected using at least one of the filtered frequency error estimate and the delta carrier phase.

19. A computer-readable media storing processor-executable instructions that, when executed by at least one processor, cause the at least one processor to:
detect one or more carrier phase discontinuities associated with a raw carrier phase;
compensate the raw carrier phase based on an accumulation of each carrier phase discontinuity of the one or more carrier phase discontinuities; and
generate a net compensated carrier phase including the compensation to the raw carrier phase.

20. The computer-readable media of claim 19, wherein the at least one processor caused to compensate the raw carrier phase is further caused to:
determine a number of cycles to compensate the raw carrier phase based on an identification of a phase-related candidate and the accumulation of each carrier phase discontinuity of the one or more carrier phase discontinuities; and
apply the number of cycles to the raw carrier phase.
